(19) United States
(12) Patent Application Publication
(10) Pub. No.: US 2024/0012014 A1
(43) Pub. Date: Jan. 11, 2024

(54) METHOD AND EQUIPMENT FOR TRACEABILITY OF BIOLOGICAL SAMPLES

(71) Applicant: DREAMPATH DIAGNOSTICS, Strasbourg (FR)

(72) Inventors: Pablo JORDAN NAVAS, Madrid (ES); Valerie WILHELM, Eschau (FR)

(21) Appl. No.: 18/338,844

(22) Filed: Jun. 21, 2023

(30) Foreign Application Priority Data
Jul. 5, 2022 (FR) 2206858

(51) Int. Cl. G01N 35/00; G06V 10/20; G06T 7/194

(52) U.S. Cl. CPC G01N 35/00732; G06V 10/255; G06T 7/194; G01N 2035/00792

(57) ABSTRACT

The equipment for traceability of biological samples placed in embedding cassettes stored in baskets includes an apparatus equipped with a device for detecting and reading encoded data and a controller of the device for detecting and reading encoded data, and a computer processor configured to automatically determine an optimal work zone, based on the model of basket housing cassettes, generate a signal representative of the zone, and transmit the corresponding information to the controller for the device for detecting and reading the encoded data. There is also an image capture device configured to capture and transmit at least one image of at least a portion of the basket. The computer processor is configured to search for a structural feature specific to a basket and to identify from the captured image of the portion of the basket, the model of the basket and determine the corresponding optimal work zone.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a method and equipment for traceability of biological samples placed in embedding cassettes.

### 2. Description of Related Art Including Information Disclosed Under 37 CFR 1.97 and 37 CFR 1.98

In the context of the medical support of a patient or that of research work in the human, animal or plant domain, tissue or cell samples are commonly carried out for histological and/or molecular analysis, intended or not for establishing a diagnosis.

In order to allow perfect viewing under the microscope of the analyzed cell or tissue structures, such samples are the subject of a prior preparation including different steps.

In summary, during the latter, the fresh samples, arranged in sampling pots filled with formaldehyde during their collection, are transferred into perforated embedding cassettes, to undergo a dehydration phase, then a step of embedding in paraffin leading to blocks of biological samples. Fine and regular cuts, taken from the blocks, are then spread on object-holder slides, further undergo different treatments intended to color the structural elements to allow them to be read under the microscope, and finally are covered with a resin and a slide ensuring their protection during different subsequent manipulations.

All these steps of preparing biological samples for their analysis involve numerous manipulations during which measurements to ensure traceability must be implemented.

Automated solutions have already been proposed for this purpose, in particular as regards the traceability of biological samples stored in paraffin blocks or on object-holder slides.

As a reminder, in a conventional manner, during its collection, each biological sample is assigned a unique reference number, provided by the computer system of the facility that sampled it. This number connects it to the patient from which it comes and remains with it until it is destroyed, in the form of encoded data, of the barcode, matrix code, or RFID chip type, affixed to its various storage media while they are being prepared.

As mentioned above, a step of the process of preparing the biological materials with a view to their analysis consists of dehydrating them by means of a dedicated apparatus, commonly referred to as a “tissue processor”, and to replace the water contained in their cells with paraffin, in order to obtain blocks from which fine cuts can then be taken. To accomplish this step, the samples are placed individually in openwork cassettes, provided with sample identification data, and themselves grouped together in baskets facilitating their handling, provided with the “tissue processors” and for which different models are available, differing from each other by their shape and/or their dimensions.

For purposes of traceability, when the baskets are filled with cassettes, it is customary to check whether the number of cassettes present in each basket does indeed match the number of cassettes that may have been prepared. In the event of a difference, a search for the error can thus be carried out, in order to find, where appropriate, a cassette forgotten on a bench with its content, or to ensure that all of the samples received by the laboratory were placed in the cassettes and have consequently been treated. Since the retention time of the samples in the formaldehyde is very short, such control proves to be essential in order to avoid any unintentional loss of material.

Obviously, performing this verification manually proves particularly tedious and time-consuming, in view of the ever-greater number of cassettes to be handled, due in particular to the growth of the rate of incidence of certain diseases, such as in particular cancer.

Therefore, the present applicant has already proposed equipment, described in publication EP 3 795 253, defining a rational solution for overcoming the problems resulting from the obsolescence of manual traceability methods, effectively and reliably managing the embedding cassettes during the step of dehydrating the biological samples, and which is compatible with all existing models of baskets for existing “tissue processors”.

The present invention falls within the same context and has the purpose of proposing an alternative solution to that described in document EP 3 795 253, which allows an even more rapid and effective implementation of traceability operations carried out by personnel likely to intervene during the dehydration phase of the biological samples placed in embedding cassettes, and thus avoid any risk of error, or loss of material to ultimately guarantee the establishment of reliable diagnostics assigned to the correct patient.

### BRIEF SUMMARY OF THE INVENTION

To this end, the present invention relates to equipment for the traceability of biological samples placed in embedding cassettes having an identification face provided with encoded data and stored, their respective identification faces all being visible, in baskets, having several models differing from each other by their general shape and/or dimensions, said equipment including:
at least one apparatus equipped with means for detecting and reading encoded data configured to detect and read, during the same reading session, the encoded data affixed to cassettes contained in at least one basket and control means of the means for detecting and reading encoded data,
computer processing means configured to automatically determine an optimal work zone of the means for detecting and reading encoded data, based on the model of basket that is housing said embedding cassettes, generate a signal representative of said zone and transmit the corresponding information to the means for controlling and reading the encoded data,
characterized in that it further includes image capture means configured to capture and transmit to the computer processing means at least one image of at least one portion of the basket housing the embedding cassettes, and in that the computer processing means are configured to search in the captured image for a structural feature specific to a model of basket and to identify, from the captured image of the portion of the basket, which model of the basket is housing said embedding cassettes and to determine the corresponding optimal work zone of the means for detecting and reading encoded data.

Furthermore, another characteristic of the equipment according to the invention is further defined by the fact that the image capture means define the means for detecting and reading encoded data.

The invention also relates to a method for traceability of biological samples placed in embedding cassettes having an identification face provided with encoded data and stored, their respective identification faces all being visible, in baskets having several models that differ from one another by their general shape and/or their dimensions, said method being implemented by means of an equipment as described above and including the steps of:
automatically determining, through computer processing means, an optimal work zone for means for detecting and reading encoded data according to the model of basket housing the embedding cassettes,
detecting and reading encoded data through the means for detecting and reading encoded data only at the previously determined optimal work zone, characterized in that to determine the optimal work zone for the means for detecting and reading encoded data, the following steps are carried out:
in a manner associated with each basket model, information relating to at least one structural feature specific to that model, information relating to an optimal work zone for that same basket, of means for detecting and reading encoded data, and/or information relating to its general shape and its dimensions, is saved in memory means of computer processing means,
at least one basket containing embedding cassettes, the faces of which provided with identification data being visible, is placed in the reading field of image capture means,
at least one image of at least one portion possibly exhibiting a structural feature of this same basket is acquired through the image capture means and it is transmitted to the computer processing means,
the presence of a specific structural feature is searched for in said image, using the computer processing means,
in the event a specific structural feature is detected, information relating to the corresponding optimal work zone of the means for detecting and reading encoded data, and/or the shape and dimensions of the corresponding basket, is searched for in the memory means, and the means for detecting and reading the encoded data are activated in the optimal zone only, or
in the event a specific structural feature is not detected, at least one order of magnitude of a length of one side of the basket is determined, in the memory means, information relating to the corresponding optimal work zone of the means for detecting and reading encoded data is searched for, and the means for detecting and reading the encoded data are activated in the optimal zone only.

The method according to the invention is also characterized in that during the image capture step a gray-scale image is acquired.

An additional feature of the method according to the invention is defined by the fact that, to search for certain structural features in said image, the background of the image is removed.

On the other hand, to determine an order of magnitude of a length of a basket, it may be provided, in the context of this method, to read a number of white pixels in the captured image.

Another characteristic of the present method consists in that to detect and read encoded data, the optimal zone previously determined is subdivided into several sub-zones each containing a plurality of potential presence slots of embedding cassettes and the encoded data is detected and read, slot by slot.

Furthermore, another advantageous feature of the present method is defined by the fact that during the step of detecting and reading the encoded data, for each slot, a signal representative of the success or, if appropriate, failure of the detection and the reading of the data encoded at said slot is retrieved on a user interface.

### BRIEF DESCRIPTION OF THE SEVERAL VIEWS OF THE DRAWINGS

The attached drawings show the invention:

FIG. 1, FIG. 2, FIG. 3, FIG. 4, and FIG. 5 show schematic top views of various models of baskets for storing embedding cassettes during the step of dehydrating the biological samples.

FIG. 6 shows a schematic view of an equipment according to the invention.

### DETAILED DESCRIPTION OF THE INVENTION

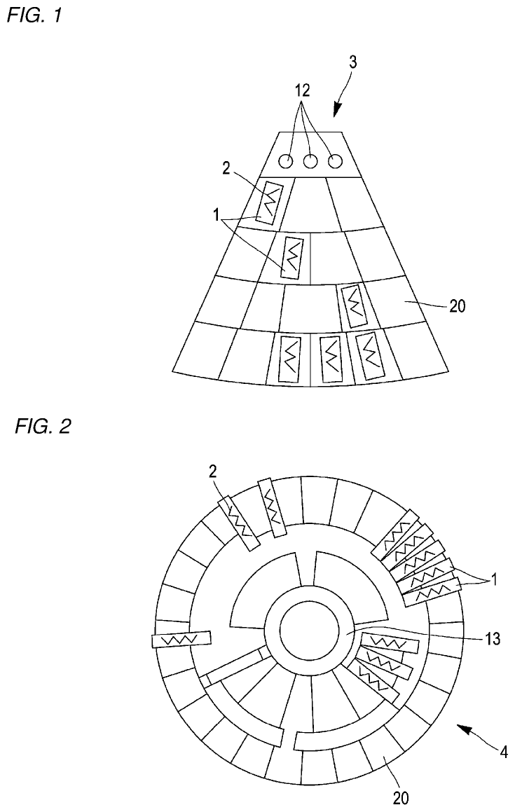

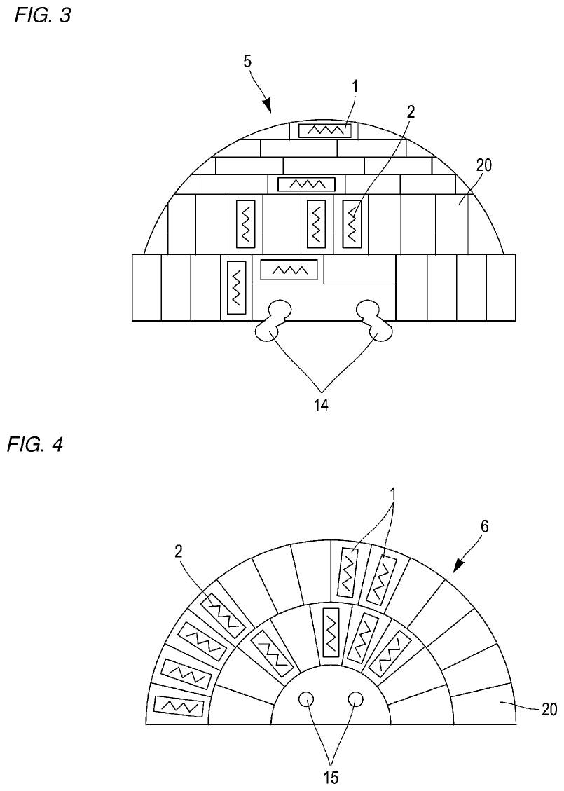

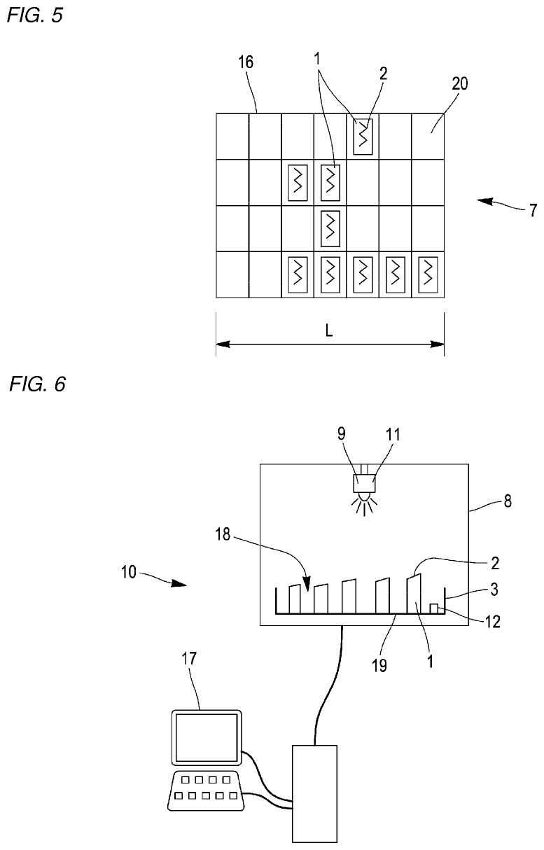

As indicated above, the present invention relates to an equipment 10 and a method for traceability of biological samples placed in embedding cassettes 1 having an identification face provided with encoded data 2, and stored their respective identification faces being visible, in baskets for which there are several models, such as in particular those 3, 4, 5, 6, 7, showed in FIGS. 1 to 5, which differ from one another by their general shape and/or their dimensions.

It is recalled that in a conventional manner, such baskets 3, 4, 5, 6, 7 are marketed with devices called “tissue processors” used to dehydrate biological samples placed in embedding cassettes 1. They have a structure determined by their manufacturer, which may for example correspond to a trapezoidal shape (see FIG. 1), a circular shape (see FIG. 2), a half-moon shape (see FIGS. 3 and 4), a parallelepiped shape (see FIG. 5), or any other shape making it possible to store a plurality of embedding cassettes 1 in an ordered manner.

In this respect, and as seen in FIGS. 1 to 5, an ordered manner of storing the embedding cassettes 1 generally consists of positioning them in individual slots 20 that the baskets 3, 4, 5, 6, 7 include, such that their faces provided with encoded identification data 2 are visible and point for example toward the inlet opening 18 of each basket 3, 4, 5, 6, 7, extending in a plane whose shape is parallel to the bottom 19 of the basket.

On the other hand, the equipment 10 according to the invention also conventionally includes an apparatus 8 equipped with means 9 for detecting and reading encoded data, configured to detect and read, during the same detection and reading session, the encoded data 2 affixed to embedding cassettes 1 contained in at least one basket 3, 4, 5, 6, 7 as well as means for controlling such means 9 for detecting and reading encoded data.

In accordance with the invention, the equipment 10 further includes computer processing means configured to automatically determine an optimal work zone of the means 9 for detecting and reading encoded data, based on the model of basket 3, 4, 5, 6, 7 that is housing said embedding cassettes 1, generate a signal representative of said optimal work zone and transmit the corresponding information to the means for controlling the means 9 for detecting and reading the encoded data.

Such a configuration has the advantage of enabling faster detection and consequently faster reading of the identification codes 2 that the embedding cassettes 1 present in a basket 3, 4, 5, 6, 7 include. Indeed, these operations will only be implemented by the means for detecting and reading encoded data on the previously determined optimal work zone, which advantageously corresponds to a potential presence zone of embedding cassettes 1, specific to each available model of basket 3, 4, 5, 6, 7. On the other hand, since the detection and reading surface is reduced, such a feature also makes it possible to limit the number of manual verification operations likely to be carried out by operators, in the event that no code is read by the means 9 for detecting and reading encoded data.

It should be noted that in the context of the invention, in order to determine the optimal work zone of the means 9 for detecting and reading encoded data, it has more specifically been provided to equip the equipment 1 with image capture means, such as for example a camera 11, if appropriate adapted to also define the means 9 for detecting and reading encoded data, and intended to capture and transmit to the computer processing means at least one image of at least one portion of the basket 3, 4, 5, 6, 7 housing the embedding cassettes 1. On the other hand, the invention also aims to configure for this purpose computer processing means such that they search, in the captured image, for a structural feature specific to one model of basket and that they determine, from the identification of the identified structural feature, the corresponding optimal work zone of the means for detecting and reading encoded data.

Thus, in practice, the invention provides for saving in the memory means of the computer processing means, associated with each model of basket 3, 4, 5, 6, 7, information relating to at least one structural feature being exclusively specific to that model, as well as information relating to an optimal work zone, for this same basket, of the means for detecting and reading encoded data, and/or additionally information relating to its general shape and its dimensions.

More specifically, with reference to FIGS. 1 to 5, in the context of the invention, the presence, on a portion of a basket, of three lugs 12 corresponds to information associated exclusively with the basket model 3 and to the information relating to an optimal work zone for the means for detecting and reading encoded data corresponding to this same basket model 3, and/or to the information as to its triangular shape and its dimensions.

Likewise, the presence of a central protrusion of cylindrical shape 13 corresponds to information associated exclusively with the basket model 4 and to the information relating to a corresponding optimal work zone for the means for detecting and reading encoded data, and/or to the information representative of its general circular shape and its dimensions.

Also, the presence on a portion of a basket of two pins 14 is information associated exclusively with basket model 5 and with information relating to an optimal work zone for this same model of the means for detecting and reading encoded data, and/or to the information relating to its half-moon shape and its dimensions allowing it to accommodate a number x of embedding cassettes 1.

On the other hand, the presence of two lugs 15 corresponds to information associated exclusively with the basket model 6 and information relating to an optimal work zone for this same model of the means for detecting and reading encoded data, and/or with information relating to its half-moon shape and its dimensions allowing it to accommodate a number y of embedding cassettes 1.

Finally, a length L1, L2, L3, . . . , Ln given on one side 16 corresponds to information associated exclusively with a basket model 7, and to the information relating to a corresponding optimal work zone of the means for detecting and reading encoded data, and/or to the information relating to its parallelepiped shape and its dimensions allowing it to accommodate a number z1, z2, z3, zn of embedding cassettes 1.

In brief, as regards the basket model 7, which has a generally parallelepiped shape, the present invention has provided for deducing its presence from the non-detection of a structural feature representative of one of the other basket models 3, 4, 5, 6 and for determining the optimal work zone for the means for detecting and reading encoded data by performing a measurement of a length L from one of its sides 16.

On the basis of the foregoing, after having carried out this preliminary step of saving in an associated manner for each basket model 3, 4, 5, 6, 7 information relating to at least one structural feature specific to that model, and information relating to an optimal work zone, for that same basket 3, 4, 5, 6, 7, of means for detecting and reading encoded data, and/or information relating to its general shape and its dimensions, the implementation of the equipment 1 consists of:
placing a basket 3, 4, 5, 6, 7 containing embedding cassettes 1 in the reading field of the camera 11 of the apparatus 8, the faces of the cassettes 1 provided with the identification data 2 thus being detectable by the camera 11,
acquiring, using the camera 11, at least one image, preferably gray scale, of at least one portion capable of having, where appropriate, three lugs 12, a cylindrical protrusion 13, two pins 14, two lugs 15, or a side 16 with length L and transmitting this image to the computer processing means,
searching in said image, using the computer processing means, and if applicable after having removed the background, for the presence, if any, of three lugs 12, a cylindrical protrusion 13, two pins 14 or two lugs 15, then
in case of any detection of three lugs 12, a cylindrical protrusion 13, two pins 14 or two lugs 15, to search in the memory means for information relating to the corresponding optimal work zone of the means for detecting and reading encoded data and/or to the shape and dimensions of the corresponding basket 3, 4, 5, 6, and to consequently activate the means for detecting and reading the encoded data on the optimal zone only, or
if there is no detection of three lugs 12, a cylindrical protrusion 13, two pins 14 or two lugs 15, to determine at least one order of magnitude of a length L of a side 16 of the basket 7, preferably by noting a number of white pixels on the captured image, then searching the memory means for information relating to the corresponding optimal work zone for the means for detecting and reading encoded data, and consequently activating the means for detecting and reading the encoded data on the optimal zone only.

It is also specified that another characteristic of the present method consists in that to detect and read the encoded data 2 affixed to embedding cassettes 1 contained in a basket 3, 4, 5, 6, 7, the optimal zone previously determined is subdivided into several sub-zones each containing several individual slots 20 for the potential presence of embedding cassettes 1 and the encoded data is detected and read, slot 20 by slot 20.

In addition, advantageously, during the step of detecting and reading the encoded data, the method according to the invention provides a step of retrieving on a user interface 17, for each slot 20, a signal representative of the success or, if appropriate, failure of the detection and reading of the data encoded at said slot 20, allowing, if appropriate, the operator to locate any code reading errors at a glance and to perform the required checks.

1. An equipment for traceability of biological samples placed in embedding cassettes having an identification face provided with encoded data, and stored their respective identification faces being visible, in baskets, of which there are several models differing from each other by their general shape and/or their dimensions, said equipment comprising:
at least one apparatus equipped with means for detecting and reading encoded data configured to detect and read, during the same reading session, the encoded data affixed to cassettes contained in at least one basket and means for controlling the means for detecting and reading encoded data,
computer processing means configured to automatically determine an optimal work zone of the means for detecting and reading encoded data, based on the model of basket that is housing said embedding cassettes, generate a signal representative of said zone, and transmit the corresponding information to the means for controlling and reading the encoded data, and
image capture means configured to capture and transmit to the computer processing means at least one image of at least a portion of the basket housing the embedding cassettes,
wherein the computer processing means are configured to search, in the captured image, for a structural feature specific to a basket and to identify from the captured image of the portion of the basket, the model of the basket housing said embedding cassettes and determine the corresponding optimal work zone of the means for detecting and reading encoded data.

2. The equipment according to claim 1, wherein the image capture means define the means for detecting and reading encoded data.

3. A method for traceability of biological samples placed in embedding cassettes having an identification face provided with encoded data, and stored their respective identification faces all being visible, in baskets having several models that differ from one another by their general shape and/or their dimensions, said method comprising the steps of:
automatically determining, through the computer processing means of equipment according to claim 1, an optimal work zone for means for detecting and reading encoded data according to the model of basket housing the embedding cassettes, and
detecting and reading encoded data through the means for detecting and reading encoded data only in the previously determined optimal work zone,
wherein the step of automatically determining the optimal work zone for the means for detecting and reading encoded data is comprised of the following steps:
saving, in a manner associated with each model of basket, information relating to at least one structural feature specific to that model, information relating to an optimal work zone for that same basket of means for detecting and reading encoded data, and/or information relating to its general shape and its dimensions, in memory means of computer processing means,
placing at least one basket containing embedding cassettes, the faces of which provided with identification data being visible, in the reading field of image capture means,
acquiring at least one image of at least one portion possibly exhibiting a structural feature of this same basket through the image capture means and transmitting the at least one image to the computer processing means,
searching for the presence of a specific structural feature in said image, using the computer processing means,
searching for, in the event a specific structural feature is detected, information relating to the corresponding optimal work zone of the means for detecting and reading encoded data, and/or the shape and dimensions of the corresponding basket in the memory means,
activating the means for detecting and reading the encoded data in the optimal zone only, or
determining, in the event a specific structural feature is not detected, at least one order of magnitude of a length L of one side of the basket,
searching for information relating to the corresponding optimal work zone of the means for detecting and reading encoded data in the memory means for detecting and reading encoded data, and
activating the means for detecting and reading the encoded data in the optimal work zone only.

4. The method according to claim 3, further comprising the step of: during the image capture step, acquiring a gray-scale image.

5. The method according to claim 3, wherein the step of searching for certain specific structural features in said image comprises the step of removing a background of the image.

6. The method according to claim 3, wherein the step of determining an order of magnitude of a length L of one side of the basket, comprises the step of noting a number of white pixels in the captured image.

7. The method according to claim 3, wherein the step of detecting and reading encoded data, comprises the steps of: subdividing the optimal zone previously determined into several sub-zones each containing a plurality of potential presence slots of embedding cassettes, and detecting and reading the encoded data slot by slot.

8. The method according to claim 7, wherein the step of detecting and reading the encoded data slot by slot comprises the step of retrieving a signal representative of the success or, if appropriate, failure of the detection and reading of encoded data at said slot on a user interface.
